(19) United States
(12) Patent Application Publication
(10) Pub. No.: US 2025/0236544 A1
(43) Pub. Date: Jul. 24, 2025

(54) SYSTEMS COMPRISING MULTIPLE CATALYSTS FOR CATALYTICALLY REMOVING OXIDIZED CONTAMINANTS FROM A FLUID AND RELATED METHODS

(71) Applicants: ARIZONA BOARD OF REGENTS ON BEHALF OF ARIZONA STATE UNIVERSITY, Scottsdale, AZ (US); WILLIAM MARSH RICE UNIVERSITY, Houston, TX (US)

(72) Inventors: Min LONG, Tempe, AZ (US); Bruce RITTMANN, Tempe, AZ (US); Chen ZHOU, Chandler, AZ (US); Michael WONG, Houston, TX (US)

(21) Appl. No.: 18/698,709

(22) PCT Filed: Oct. 4, 2022
(86) PCT No.: PCT/US2022/045695

§ 371 Date: Apr. 4, 2024

(51) Int. Cl. C02F 1/72; B01J 23/46; B01J 35/59; B01J 37/02; B01J 37/18; C02F 101/12; C02F 101/16; C02F 101/36

(52) U.S. Cl. CPC C02F 1/725; B01J 23/464; B01J 23/468; B01J 35/59; B01J 37/0215; B01J 37/18; C02F 2101/12; C02F 2101/163; C02F 2101/36

(57) ABSTRACT

The disclosure relates to a method of producing a multi-metal catalyst film and of producing a reactor system for catalytic removal of a wide variety of contaminants (for example, nitrate, nitrite, perchlorate, chlorate, chromate, selenate, chlorophenols, 2,4-D, dicamba, atrazine, trichloroacetic acid, bromochloroiodomethane, NDMA, TCE, TCA, chloroform, freons, RDX, HMX, TNT, PFOA, and PFOS) from water and wastewater. The disclosure also relates to a method of using the multi-metal catalyst for the removal of such contaminants and a system comprising the multi-metal catalyst film for removing such contaminants.

### CROSS-REFERENCE TO RELATED APPLICATIONS

This application claims the benefit of and priority to U.S. Provisional Application No. 63/252,073, filed Oct. 4, 2021, the contents of which are incorporated herein by reference in its entirety.

### STATEMENT REGARDING FEDERALLY SPONSORED RESEARCH OR DEVELOPMENT

This invention was made with government support under 1449500 awarded by the National Science Foundation and W912HQ-20-P-0006 awarded by ARMY/SSC. The government has certain rights in the invention.

### FIELD OF THE INVENTION

The invention relates to systems and methods for removing oxidized contaminants from water or wastewater using a multi-metal nanocatalyst film.

### BACKGROUND OF THE INVENTION

Nanoparticles have received considerable attention due to their unique optical, electronic, and magnetic properties. In forming multi-metal nanoparticles, different metals combine to show novel properties. Multi-metal nanoparticles are important as compared to those of monometallic nanoparticles due to the presence of an extra degree of freedom. They have a greater surface area, which increases their adsorption power and hence acts as efficient catalysts compared to monometallic nanoparticles. Multi-metal nanoparticles can be synthesized in different shapes, sizes, and structures, owing the following effects: (a) geometric or ensemble effect, (b) ligand or electronic effect, (c) stabilization effect, (d) synergistic effect, and (e) bi-functional effect. Through multi-metallization, the catalytic properties of the resulting nanoparticles can be improved to an extent not achievable by monometallic catalysts.

Multi-metal catalysts usually comprise at least one noble metal, which include Ru, Rh, Ir, Pd, and Pt, or a noble metal and a transition metal known as a promoter metal, which include Cu, Sn, Ag, Ni, Fe, and In. Multi-metal catalysts can be synthesized in a variety of ways, including in a gas phase, in solution, or supported onto a solid substrate matrix. The basic methods of preparing multi-metal materials can be broadly classified into the following six categories: chemical reduction, thermal decomposition of appropriate precursors, electrochemical syntheses, radiolysis, and sonochemical synthesis. Among these methods, the chemical-reduction method can be further sub-classified into co-reduction, reduction of multi-metal complexes, and successive reduction. For successive reduction (i.e., decoration methods), the deposition of second metal onto a pre-formed metal nanostructure is a popular method among material chemists for engineering multi-metal materials with specific ‘designer’ nanostructures. However, if the reducing agent employed is strong, then the reduction process is too quick and poorly controllable. Accordingly, systems and methods that can overcome the roadblocks of making multi-metal catalysts are needed.

### SUMMARY OF THE INVENTION

The disclosure is directed to methods and systems of removing oxidized contaminants from water or wastewater via multi-metal catalysis. The disclosure is also directed to methods and systems of synthesizing a catalyst film comprising multi-metal nanocatalysts. The disclosure is further directed to a method of establishing a system of removing oxidized contaminants from water or wastewater via multi-metal catalysis.

The method of establishing a catalyst film for removal of oxidized contaminants from a fluid and the method of establishing a reactor for long-term removal of oxidized contaminants from a fluid begin with providing a non-porous gas-transfer membrane, which has a gas-phase side and a liquid-phase side; contacting the liquid-phase side of the non-porous gas-transfer membrane with a core-metal medium comprising core metal ions; and contacting the gas-phase side of the non-porous gas-transfer membrane with hydrogen (H₂) gas. The gas-phase side of the non-porous gas-transfer membrane is contacted with H₂ gas at a sufficient partial pressure to convert at least 90% of the core metal ions in the core-metal medium to an elemental form. The elemental form of the core metal is in the form of a nanoparticle and is deposited on the liquid-phase side of the non-porous gas-transfer membrane, thereby forming a core metal film. The method next comprises contacting the liquid-phase side of the non-porous gas-transfer membrane deposited with the core metal film with a promoter-metal medium comprising promoter metal ions; and contacting the gas-phase side of the non-porous gas-transfer membrane deposited with the core metal film with H₂ gas at a sufficient partial pressure to reduce at least 90% of the promoter metal ions in the promoter-metal medium to an elemental form or a lower oxidation state that is greater than 0. The reduced promoter metal ions is in the form of a nanoparticle and is deposited on the core metal film thereby forming a multi-metal catalyst film on the liquid-phase side of the non-porous gas-transfer membrane.

In some implementations, the method of establishing a catalyst film for removal of oxidized contaminants from a fluid further comprises combining at least one salt of a core metal and a solvent to produce the core-metal medium; and combining at least one salt of a promoter metal and a solvent to produce the promoter-metal medium. In some aspects, the solvent of the core-metal medium and the solvent of the promoter-metal medium each is selected from the group consisting of: water, an aqueous salt solution, hydrochloric acid, methanol, ethanol, acetonitrile, toluene, dichloromethane, chloroform, tetrahydrofuran, and a combination thereof. In certain embodiments, the solvent of the core-metal medium is deionized water, and the solvent of the promoter-metal medium is deionized water. In some embodiments, the solvent of core-metal medium and the solvent of the promoter-metal medium each is selected from deionized water or an aqueous salt solution.

In some aspects, the at least one salt of the core metal is selected from the group consisting of: gold salt, silver salt, platinum salt, palladium salt, rhodium salt, and ruthenium salt, while the at least one salt of the promoter metal is selected from the group consisting of: gold salt, silver salt, platinum salt, palladium salt, rhodium salt, ruthenium salt, iridium salt, osmium salt, copper salt, tin salt, nickel salt, molybdenum salt, wolframium salt, rhenium salt, indium salt, gallium salt, and cobalt salt. It is essential that the promoter metal is different from the core metal. In some implementations where the core-metal medium comprises a salt of a first core metal and a salt of second core metal, the salt of the salt of the first core metal is selected from the group consisting of: gold salt, silver salt, platinum salt, palladium salt, rhodium salt, and ruthenium salt, and the salt of the second core metal is selected from the group consisting of: gold salt, silver salt, platinum salt, palladium salt, rhodium salt, ruthenium salt, iridium salt, osmium salt, copper salt, tin salt, nickel salt, molybdenum salt, wolframium salt, rhenium salt, indium salt, gallium salt, and cobalt salt. In such implementations, the second core metal is different than the first core metal and the promoter metal.

In some aspects, the core metal ions comprise at least one metal ion selected from the group consisting of: Au³⁺, Ag⁺, Pt²⁺, Pd²⁺, Rh³⁺, and Ru³⁺. The promoter metal ions may be selected from at least one metal ion selected from the group consisting of: Au³⁺, Ag⁺, Pt²⁺, Pd²⁺, Rh³⁺, Ru³⁺, Ir⁴⁺, Os⁴⁺, Cu²⁺, Sn²⁺, Ni²⁺, Mo⁶⁺, W⁶⁺, Re⁷⁺, In³⁺, Ga²⁺, and Co²⁺. In other aspects, the core-metal medium comprises a first core metal ion selected from the group consisting of: Au³⁺, Ag⁺, Pt²⁺, Pd²⁺, Rh³⁺, and Ru³⁺ and a second core metal ion selected from the group consisting of: Au³⁺, Ag⁺, Pt²⁺, Pd²⁺, Rh³⁺, Ru³⁺, Ir⁴⁺, Os⁴⁺, Cu²⁺, Sn²⁺, Ni²⁺, Mo⁶⁺, W⁶⁺, Re⁷⁺, In³⁺, Ga²⁺, and Co²⁺, wherein the second core metal ion is different the first core metal ion and the promoter metal ions.

For the core-metal medium and the promoter-metal medium, the concentration of the core metal ions in the core-metal medium should be greater than the concentration of the promoter metal ions in the promoter-metal medium. In some aspects, the concentration of the core metal ions in the core-metal medium is 0.001-5 mM. In certain implementations, the pH of the core-metal medium and the pH of the promoter-metal medium is 3-7.

In some aspects, the sufficient partial pressure of H₂ gas to convert at least 90% of the core metal ions in the core-metal medium to an elemental form comprises the H₂ gas source is a partial pressure of 10-20 psig. In some aspects, the sufficient partial pressure of H₂ gas to convert at least 90% of the promoter metal ions in the promoter-metal medium to an elemental form or a lower oxidation state that is greater than 0 is a partial pressure of 10-20 psig.

The described method of removing contaminants from a fluid removes at least one contaminant selected from the group consisting of: an oxyanion, a pesticide, a disinfection byproduct, an organic solvent, a freon, an explosive, and per- and poly-fluoroalkyl substances (PFAS). In one aspect, the method comprises contacting a fluid containing contaminants with a multi-metal catalyst film produced according to the method described above; and contacting the multi-metal catalyst film with H₂ gas at a sufficient partial pressure to reduce the oxidized contaminants. In another aspects, the method comprises establishing a multi-metal catalyst film, the multi-metal catalyst film comprising a core metal film and nanoparticles of at least one promoter metal. The core metal film is deposited on a non-porous gas-transfer membrane, and the nanoparticles of the at least one promoter metal are deposited on the core metal film. In certain embodiments, the core metal and promoter metal are different, and the core metal film comprises nanoparticles of at least one core metal selected from the group consisting of: gold, silver, platinum, palladium, rhodium, and ruthenium, while the at least one promoter metal is selected from the group consisting of: gold, silver, platinum, palladium, rhodium, ruthenium, iridium, osmium, copper, tin, nickel, molybdenum, wolframium, rhenium, indium, gallium, and cobalt. The method further comprises contacting a fluid containing contaminants with the multi-metal catalyst film; and contacting the multi-metal catalyst film with H₂ gas at a sufficient partial pressure to reduce the contaminants.

In some implementations, the contaminants are at least one member selected from the group consisting of nitrate, nitrite, perchlorate, chlorate, chromate, selenate, chlorophenols, 2,4-D, dicamba, atrazine, trichloroacetic acid, bromochloroiodomethane, N-nitrosodimethylamine (NDMA), trichloroethylene (TCE), trichloroethane (TCA), and chloroform, a freon, hexogen (RDX), octogen (HMX), and trinitrotoluene (TNT), perfluorooctanoic acid (PFOA), and perfluorooctanesulfonic acid (PFOS). In particular implementations, the multi-metal catalyst film is contacted with H₂ gas at a partial pressure of 20 psig to remove the contaminants from the fluid. In such implementations, the contaminant may be PFAS.

In some embodiments, the core metal ions comprises at least one metal ion selected from the group consisting of: Au³⁺, Ag⁺, Pt²⁺, Pd²⁺, Rh³⁺, and Ru³⁺; and the promoter metal ions comprises at least one metal ion selected from the group consisting of: Au³⁺, Ag⁺, Pt²⁺, Pd²⁺, Rh³⁺, Ru³⁺, Ir⁴⁺, Os⁴*, Cu²⁺, Sn²²⁺, Ni²⁺, Mo⁶⁺, W⁶⁺, Re⁷⁺, In³⁺, Ga²⁺, and Co²⁺. In certain implementations, the core-metal medium comprises a first core metal ion selected from the group consisting of Au³⁺, Ag⁺, Pt²⁺, Pd²⁺, Rh³⁺, and Ru³⁺ and a second core metal ion selected from the group consisting of: Au³⁺, Ag⁺, Pt²⁺, Pd²⁺, Rh³⁺, Ru³⁺, Ir⁴⁺, Os⁴*, Cu²⁺, Sn²⁺, Ni²⁺, Mo⁶⁺, W⁶⁺, Re⁷⁺, In³⁺, Ga²⁺, and Co²⁺. In such implementations, the second core metal ion is different than the first core metal ion and the promoter metal ions.

In some aspects, the sufficient partial pressure of H₂ gas to convert at least 90% of the core metal ions in the core-metal medium to an elemental form is 10-20 psig. In some aspects, the gas-phase side of the non-porous gas-transfer membrane is contacted with H₂ gas at a sufficient partial pressure to convert at least 99% of the core metal ions in the core-metal medium to an elemental form. In certain implementations, the diameters of the nanoparticles of the core metal and the nanoparticles of the promoter metal are less than 100 nm or less than 10 nm.

In some implementations, the step of establishing a multi-metal catalyst film comprises providing a non-porous gas-transfer membrane having a gas-phase side and a liquid-phase side; contacting the liquid-phase side of the non-porous gas-transfer membrane with a core-metal medium comprising core metal ions; and contacting the gas-phase side of the non-porous gas-transfer membrane with H₂ gas at a sufficient partial pressure to convert at least 90% of the core metal ions in the core-metal medium to an elemental form. The elemental form of the core metal is in the form of a nanoparticle and is deposited on the liquid-phase side of the non-porous gas-transfer membrane thereby forming a core metal film. The step of establishing a multi-metal catalyst film further comprises contacting the liquid-phase side of the non-porous gas-transfer membrane deposited with the core metal film with a promoter-metal medium comprising promoter metal ions; and contacting the gas-phase side of the non-porous gas-transfer membrane deposited with the core metal film with H₂ gas at a sufficient partial pressure to convert at least 90% of the promoter metal ions in the promoter-metal medium to an elemental form or a lower oxidation state that is greater than 0. The reduced promoter metal ions is in the form of a nanoparticle and is deposited on the core metal film thereby forming a multi-metal catalyst film on the liquid-phase side of the non-porous gas-transfer membrane.

In such implementations, the concentration of the core metal ions in the core-metal medium is greater than the concentration of the promoter metal ions in the promoter-metal medium. In some aspects, the concentration of core metal ions in the core-metal medium is 0.001-5 mM. In some aspects, the pH of the core-metal medium and the pH of the promoter-metal medium is 3-6. In certain embodiments, the solvent of the core-metal medium and the solvent of the promoter-metal medium each is selected from the group consisting of: water, salt solution, hydrochloric acid, methanol, ethanol, acetonitrile, toluene, dichloromethane, chloroform, tetrahydrofuran, and combinations thereof. In particular embodiments, the solvent of the core-metal medium is deionized water, and the solvent of the promoter-metal medium is deionized water.

The described system for removing contaminants from a fluid removes at least one contaminant selected from the group consisting of: an oxyanion, a pesticide, a disinfection byproduct, an organic solvent, a freon, an explosive, and PFAS. In particular embodiments, the contaminants are at least one member selected from the group consisting of: nitrate, nitrite, perchlorate, chlorate, chromate, selenate, chlorophenols, 2,4-D, dicamba, atrazine, trichloroacetic acid, bromochloroiodomethane, NDMA, TCE, TCA, chloroform, RDX, HMX, TNT, PFOA, and PFOS.

The system comprises a non-porous gas-transfer membrane; a catalyst film comprising nanoparticles of at least one core metal and nanoparticles of at least one promoter metal; and a H₂ gas source. The catalyst film is deposited on the non-porous gas-transfer membrane. The H₂ gas source provides H₂ gas to the non-porous gas-transfer membrane. The nanoparticles of the first core metal and the nanoparticles of the at least one promoter metal are configured to catalyze the reduction of contaminants when provided a sufficient amount of H₂ gas to catalyze the reduction of contaminants. In some implementations where the non-porous gas-transfer membrane comprises a gas-phase side and a liquid-phase side, the catalyst film is deposited on the liquid-phase side and the H₂ gas source delivers H₂ gas to the gas-phase side. In particular embodiments, the non-porous gas-transfer membrane is a hollow-fiber membrane.

In some embodiments, the nanoparticles have a diameter of less than 100 nm or less than 10 nm. in some aspects, the loading density of the at least one core metal is 9-14 g/m² and the loading density of the at least one promoter metal is about 0.1 g/m².

In a particular embodiment of the system, the at least one core metal is selected from the group consisting of: gold, silver, platinum, palladium, rhodium, and ruthenium, while the at least one promoter metal is selected from the group consisting of: gold, silver, platinum, palladium, rhodium, ruthenium, iridium, osmium, copper, tin, nickel, molybdenum, wolframium, rhenium, indium, gallium, and cobalt. In such embodiments, the at least one promoter metal is different from the at least one core metal.

In certain embodiments of the system, the catalyst film comprises nanoparticles of a first core metal selected from the group consisting of: gold, silver, platinum, palladium, rhodium, and ruthenium and a second core metal selected from the group consisting of: gold, silver, platinum, palladium, rhodium, ruthenium, iridium, osmium, copper, tin, nickel, molybdenum, wolframium, rhenium, indium, gallium, and cobalt. In such embodiments, the second core metal is different than the first core metal and the at least one promoter metal.

### BRIEF DESCRIPTION OF THE DRAWINGS

FIG. 1 illustrates, in accordance with certain embodiments, a bench-scale example of the multi-metal membrane catalyst film reactor (MCfR) system. The bench-scale multi-metal MCfR was made of a 30-cm glass tube connected with plastic tubing through a recirculation pump (Masterflex, USA) that gave a recirculation rate of 150 mL/min to ensure the MCfR's liquid contents are well-mixed. The tube had a bundle of 120 24-cm hollow-fiber membranes (polypropylene; Teijin, Ltd., Japan) with 200 μm OD, 100 μm ID, and wall thickness at 50 μm. The total membrane surface area was 181 cm², and the working volume was 40 mL.

FIGS. 2A-2C depict, in accordance with certain embodiments, concentration changes of Pd(II), Rh(III) and Ir(IV) in the decoration coating methods.

FIGS. 3-A1 to 3-A4 depict exemplary transmission electron microscopy images and electron energy loss spectroscopy images showing the characteristics of a Pd⁰/Rh⁰-film in the MCfR made with the disclosed decoration-coating method.

FIGS. 4A-4C compares the concentration of Pd ions and Rh ions in the medium for establishing a catalyst film according to a method using a single precursor medium (FIG. 4A) versus using the decoration method disclosed herein (FIGS. 4B and 4C).

FIGS. 5A-5E measure, in accordance with certain embodiments, PFOA removal and defluorination in different monometallic and decoration-method-produced bimetallic catalysts at pH 7.

FIGS. 6A-6D depict, in accordance with certain embodiments, reduction of nitrate (FIGS. 6A and 6B), chlorate (FIG. 6C), and perchlorate (FIG. 6D) by different decoration-method-produced bimetallic catalysts. The starting concentration of nitrate, chlorate, and perchlorate in the contaminated liquid was 4 mM, 0.1 mM, and 0.1 mM, respectively.

FIG. 7 depicts, in accordance with certain embodiments, the concentrations of PFOA in the continuous operation of MCfR with a Pd/Ir catalyst film made using the disclosed decoration method. The starting concentration of PFOA in the contaminated liquid was 10 μM.

FIG. 8 depicts, in accordance with certain embodiments, a schematic diagram of bimetallic catalysts Pd—Rh and Pd—Ru and a trimetallic catalyst Pd—Rh—Ru.

FIG. 9 depicts, in accordance with certain embodiments, a comparison of PFOA defluorination and nitrate reduction rates of monometallic, bimetallic, and trimetallic catalysts made with palladium, rhodium, and/or ruthenium nanoparticles.

### DETAILED DESCRIPTION OF THE INVENTION

Detailed aspects and applications of the invention are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. It should be noted that there are many different and alternative configurations, devices, and technologies to which the disclosed inventions may be applied. The full scope of the inventions is not limited to the examples that are described below.

The singular forms “a,” “an,” and “the” include plural referents unless the context clearly dictates otherwise. Thus, for example, reference to “a step” includes reference to one or more of such steps.

The term “about” when used in the context of numeric values denotes an interval of accuracy that is familiar and acceptable to a person skilled in the art. The interval is ±10% of the given numeric value, +5% of the given numeric value, or +2% of the given numeric value.

As used herein, the term “catalyst film” refers to a film of metal nanocatalysts.

As used herein, an “autocatalytic metal” is a metal that could serve as a catalytic surface for continuous deposition of 0-valent metal formed by continuous reduction of the ionic metal by hydrogen (H₂) gas. Accordingly, in some aspects, autocatalytic metals include noble metals.

A reactor that enables the controllable synthesis of well-dispersed multi-metal nanocatalysts without adding extra polymeric stabilizer ligands and multi-metal nanoclusters is disclosed herein. The disclosed multi-metal nanocatalyst reactor is a green and sustainable approach that overcomes the disadvantages of mono-metallic reactors and possesses excellent performance in reducing challenging contaminants.

In one aspect of the invention, the catalytic reactor system comprises a catalyst film comprising nanoparticles of at least two types of metals that are deposited on a gas-transfer membrane and a hydrogen (H₂)-gas source. The catalyst film comprises nanoparticles of a core metal and nanoparticles of a promoter metal. The core metal is preferably one where the core metal's ion can be autocatalytically reduced to a catalytic nanoparticle. In other words, the nanoparticles of the core metal must comprise an autocatalytic metal. Thus, in some embodiments, the core metal is selected from the group consisting of: silver, platinum, palladium, rhodium, and ruthenium. In some aspects, the nanoparticles in the core metal comprise an autocatalytic metal and another metal, which may or may not be autocatalytic. For example, the nanoparticles in the core metal comprises two metals selected from the group consisting of: gold, silver, platinum, palladium, rhodium, ruthenium, iridium, osmium, copper, tin, nickel, molybdenum, wolframium, rhenium, indium, gallium, and cobalt, wherein at least one of the two metals is an autocatalytic metal. The promoter metal is any metal that can form metal ions in solution. As such, the promoter metal may be a different autocatalytic metal than the core metal. In some embodiments, the promoter metal is selected from the group consisting of: gold, silver, platinum, palladium, rhodium, ruthenium, iridium, osmium, copper, tin, nickel, molybdenum, wolframium, rhenium, indium, gallium, and cobalt. It is crucial that core metal is a different metal than the promoter metal.

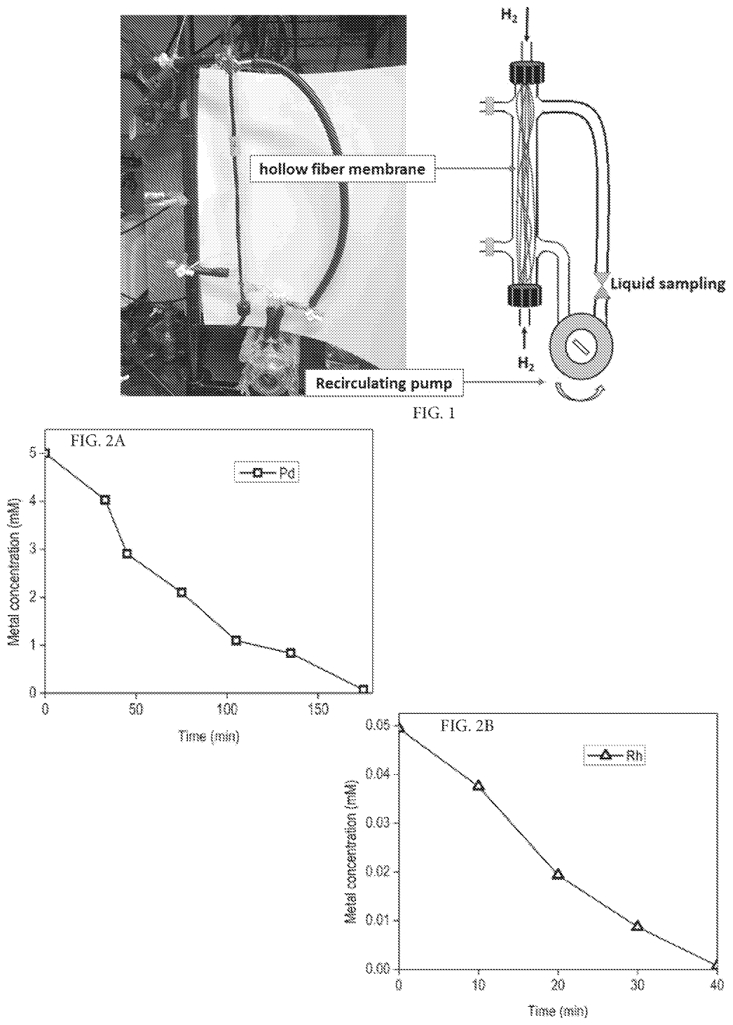

The disclosed catalytic reactor system is a hydrogen-based membrane catalyst-film reactor (H₂-MCfR) and comprises the catalyst film described herein, a gas-transfer membrane on which the catalyst film is deposited, and a hydrogen-gas source. In some embodiments, the gas-transfer membrane is non-porous. H₂ gas is delivered to the lumen at a carefully controlled pressure, and the H₂ diffuses through the walls in a bubbleless form. The H₂ gas functions as the electron donor to drive autocatalytic reduction of the soluble metals, which spontaneously deposit as nanoparticles on the membrane wall of the liquid-phase side. The metals on the catalyst film may be reduced completely to their elemental form or only be partially reduced. In some aspects, the autocatalytic core metal of the catalyst film is reduced completely to its elemental form. The H₂ gas also facilitates the reduction of contaminants by the metal nanoparticles on the catalyst film. A bench-scale example of this system is shown in FIG. 1.

The target contaminants that could be removed by the disclosed catalytic reactor system include, but are not limited to: oxyanions (such as nitrate, nitrite, perchlorate, chlorate, chromate, and selenate), pesticides (such as chlorophenols, 2,4-D, dicamba, and atrazine), disinfection byproducts (such as trichloroacetic acid, bromochloroiodomethane, and N-nitrosodimethylamine (NDMA)), organic solvents (such as trichloroethylene (TCE), trichloroethane (TCA), and chloroform), freons, explosives (such as hexogen (RDX), octogen (HMX), and trinitrotoluene (TNT)), and per- and poly-fluoroalkyl substances (PFAS) (such as perfluorooctanoic acid (PFOA) and perfluorooctanesulfonic acid (PFOS)).

Compared to monometallic catalysts in an MCfR, the disclosed multi-metal nanocatalyst reactor has higher efficiency in treating contamination at environmentally relevant conditions; it enables formation of nanoparticles of metals that cannot be autocatalytically reduced and can complete reactions that are not possible with monometallic catalysts. Compared to other catalyst systems for treating contaminants, the disclosed multi-metal nanocatalyst reactor is made with a more resource-saving and energy-saving method of synthesizing of catalysts. For example, the disclosed multi-metal nanocatalyst reactor enables controllable one-pot and successive synthesis and supporting, does not need high temperature and pressure, and uses over 99% of precursors. The disclosed multi-metal nanocatalyst reactor also treats a wider spectrum of contaminants in water and wastewater. Furthermore, the disclosed multi-metal nanocatalyst reactor realizes long-term continuous treatment and possesses consistently high catalytic activity.

Method of Establishing a Reactor with Multi-Metal Nanocatalysts for Removal of Oxidized Contaminants

To establish a reactor with multi-metal nanocatalysts that removes oxidized contaminants (especially over the long term), the method comprises establishing a catalyst film comprising multi-metal nanocatalysts. In some aspects, the catalyst film comprises nanoparticles of a core metal and nanoparticles of a promoter metal, wherein the nanoparticles of the core metal form a core metal film and the nanoparticles of the promoter metal are deposited on the core metal film. The described method is an efficient, reliable, and sustainable method for the rapid synthesis of multi-metal nanocatalysts. The method enables controllable successive synthesis (decoration methods) of multi-metal nanocatalysts in ambient conditions (room temperature and pressure) without the addition of environmentally dangerous organic solvents and at >99% utilization of the multi-metal precursors (for example, the salt of a core metals and the promoter metal salts).

The method of establishing a catalyst film for removal of oxidized contaminants from a fluid comprises providing a non-porous gas-transfer membrane, wherein the non-porous gas-transfer membrane comprises a gas-phase side and a liquid-phase side and contacting the liquid-phase side of the non-porous gas-transfer membrane with a core-metal medium (a solution made from combining at least one salt of a core metal and a solvent to result in a solution comprising core metal ions). The gas-phase side of the non-porous gas-transfer membrane is contacted with hydrogen (H₂) gas at a sufficient partial pressure to convert at least 90% of the core metal ions in the core-metal medium to an elemental form. The elemental form of the core metal is in the form of a nanoparticle and is deposited on the liquid-phase side of the non-porous gas-transfer membrane. A core metal film is formed from the nanoparticles of the core metal being deposited on the liquid-phase side of the non-porous gas-transfer membrane. Once the core metal film is formed, the liquid-phase side of the non-porous gas-transfer membrane is contacted with a promoter-metal medium (a solution made from combining at least one salt of a promoter metal and a solvent to result in a solution comprising promoter metal ions) and the gas-phase side of the non-porous gas-transfer membrane is contacted with H₂ gas at a sufficient partial pressure to reduce at least 90% of the promoter metal ions in the promoter-metal medium, wherein at least 90% of the promoter metal ions are converted to an elemental form or a lower oxidation state greater than 0. The reduced form of the promoter metal is in the form of a nanoparticle and is deposited on the core metal film thereby forming a multi-metal catalyst film on the liquid-phase side of the non-porous gas-transfer membrane. In some aspects, the sufficient partial pressure of H₂ gas provided is between 1-20 psig. In particular embodiments, the sufficient partial pressure of H₂ gas provided is 20 psig.

In some aspects, the core-metal film comprises a noble metal. By coating with the noble metal ions, it induces the reduction of the transition metal ions or other noble metal in the system; thus, the overall strategy is often referred to as the noble metal-induced reduction (NMIR) method. By the NMIR method, catalyst types can be extended to a variety range of metals in the decoration methods. In some embodiments, the core metal is selected from the group consisting of: silver, platinum, palladium, rhodium, and ruthenium. In some aspects, the core metal comprises more than one metal, and in such embodiments, at least one of the core metals is an autocatalytic metal. The second core metal may be selected from the group consisting of: gold, silver, platinum, palladium, rhodium, ruthenium, iridium, osmium, copper, tin, nickel, molybdenum, wolframium, rhenium, indium, gallium, and cobalt. The promoter metal is selected from the group consisting of: gold, silver, platinum, palladium, rhodium, ruthenium, iridium, osmium, copper, tin, nickel, molybdenum, wolframium, rhenium, indium, gallium, and cobalt.

To form the multi-metal catalyst film described herein, the core metal is different than the promoter metal. The liquid-phase side of the non-porous gas-transfer membrane with the core metal film deposited may be contacted with a plurality of promoter-metal mediums to enable the decoration of a plurality of promoter metals on the core metal film. For example, the method described herein can produce a multi-metal catalyst film that comprises at least three different metals. In certain implementations, the concentration of the salt of the core metal in the core-metal medium is higher than the concentration of the salt of the promoter metal in the promoter-metal medium. For example, the ratio of the concentration of the salt of the core metal in the core-metal medium to the concentration of the salt of the promoter metal in the promoter-metal medium ranges from 100:1 to 5:1.

In some aspects, the catalyst film consists of nanoparticles of the core metal and nanoparticles of the promoter metal(s). The core metal is different than the promoter metal(s). In certain embodiments, the catalyst film consists of nanoparticles with diameter of less than 100 nm, less than 10 nm, less than 5 nm, or with an average diameter of 5 nm. In some aspects, the loading density of the catalyst film is 2.2-44 mmol/m² or 9-14 g/m² for the core metal and the loading density of the at least one promoter metal is about 0.0022-44 mmol/m² or 0.1 g/m². The catalyst film composition may be uniform along the gas-transfer membrane or vary along the gas-transfer membrane. Variation in the spatial composition of the catalyst film can be a parameter to modify for improving reactor performance.

In some aspects, the gas-phase side of the non-porous gas-transfer membrane is contacted with H₂ gas at a sufficient partial pressure to convert at least 99% of the metal salt in the core-metal medium and/or the promoter-metal medium is reduced. In particular implementations, at least 90% of the core metal ions in the core-metal medium is converted to elemental form within 180 minutes of contact with the core-metal medium and H₂ gas. In certain implementations, at least 99% of the core metal ions in the core-metal medium is converted to elemental form within 180 minutes of contact with the core-metal medium and H₂ gas. In some aspects, at least 90% of the promoter metal ions in the promoter-metal medium is converted to elemental form or lower oxidation state that is greater than 0 within 40 minutes of contact with the promoter-metal medium and H₂ gas. In a particular embodiment, at least 99% of the promoter metal ions in the promoter-metal medium is converted elemental form or lower oxidation state that is greater than 0 within 40 minutes of contact with the promoter-metal medium and H₂ gas. In some aspects, the sufficient partial pressure of H₂ gas provided is between 1-20 psig. In particular embodiments, the sufficient partial pressure of H₂ gas provided is 20 psig.

a. Core-Metal Medium

The core-metal medium is made from combining at least one salt of a core metal and a solvent to produce a solution comprising core metal ions. In some embodiments, the promoter metal salt is a salt of a noble metal. In certain embodiments, the core metal is selected from gold, silver, platinum, palladium, rhodium, and ruthenium. The solvent is any inorganic or organic liquid that enables that salt of the core metal to rapidly dissolve. Accordingly, in some aspects, the solvent may be selected from at least one of water, an aqueous salt solution, hydrochloric acid, methanol, ethanol, acetonitrile, toluene, dichloromethane, chloroform, or tetrahydrofuran. In certain implementations, the solvent is deionized water. In some implementations, the solvent is an aqueous salt solution, such as, for example, a solution comprising deionized water and a pH buffer.

The salts of core metal should rapidly dissolve in the solvent and release soluble core metal ions. Soluble core metal ions include Au³⁺, Ag⁺, (PtCl₄)²⁺, (PdCl₄)²⁺, Rh³⁺, and Ru³⁺. Exemplary salts of the core metal for making the core-metal medium include gold chloride (AuCl₃), silver nitrate (AgNO₃), sodium tetrachloropalladate (Na₂PtCl₄), sodium tetrachloropalladate (Na₂PdCl₄), ruthenium chloride (RhCl₃), and ruthenium chloride (RuCl₃).

The range of the concentration of the metal ion in the core-metal medium is wide, for example, 0.005-100 mM, 0.01 to 100 mM, or 1 to 20 mM. In some aspects, the concentration of core metal ion in the core-metal medium is 0.005-5 mM, for example 1-5 mM or 5 mM.

In some embodiments, the core-metal medium further comprises an acid, a base, and/or pH buffers. The acid may be, for example, hydrochloric acid. The base may be, for example, sodium hydroxide. The pH buffer may be, for example, a potassium phosphate buffer. In particular embodiments, the pH buffer adjusts the pH of the core-metal medium to anywhere in the range of 0 and 14. In certain embodiments, the pH of the core-metal medium is between 3 and 9, for example, a pH of 3-7, 3.5-7.5, 6.5-8.5, or about 7. In some aspects, the pH of the core-metal medium is 7±0.5, 7±0.4, 7±0.3, 7±0.2, 7±0.1, or 7±0.05.

b. Promoter-Metal Medium

The promoter-metal medium is made from combining at least one promoter metal salt and a solvent to produce a solution comprising promoter metal ions. In some embodiments, the promoter metal salt is a salt of a noble metal. In certain embodiments, the promoter-metal ion in the promoter-metal medium is selected from gold, silver, platinum, palladium, rhodium, ruthenium, iridium, osmium, copper, tin, nickel, molybdenum, wolframium, rhenium, indium, gallium, and cobalt. In some aspects, the metal ions in the promoter-metal medium are not reduced to an elemental form, but to a lower oxidation state that is greater than 0. In such embodiments, the promoter metal may be molybdenum, wolframium, or rhenium.

The solvent may be selected from at least one of water, an aqueous salt solution, hydrochloric acid, methanol, ethanol, acetonitrile, toluene, dichloromethane, chloroform, or tetrahydrofuran. In certain implementations, the solvent is deionized water. In some implementations, the solvent is an aqueous salt solution, such as, for example, a solution comprising deionized water and a pH buffer. The solvent of the promoter-metal medium may be different than the solvent of the core-metal medium.

The salts of promoter metal should rapidly dissolve in the solvent and release soluble metal ions. Soluble promoter metal ions include Au³⁺, Ag⁺, Pt²⁺, Pd²⁺, Rh³⁺, Ru³⁺, Ir⁴⁺, Os⁴⁺, Cu²⁺, Sn²⁺, Ni²⁺, Mo⁶⁺, W⁶⁺, Re⁷⁺, In³⁺, Ga²⁺, and Co²⁺. Exemplary salts of the promoter metal in the promoter-metal medium include AuCl₃, AgNO₃, Na₂PtCl₄, Na₂PdCl₄, RhCl₃, RuCl₃, K₂IrCl₆, K₂OsC₁₆, CuCl₂, SnCl₂, NiCl₂, MoO₃, Na₂WO₄, Re₂O₇, InCl₃, GaCl₂, and CoCl₂.

The range of the concentration of the metal ion in the promoter-metal medium is wide, for example, 0.005-100 mM or 0.001 to 20 mM. In some aspects, the concentration of promoter metal ion in the promoter-metal medium is 0.005-5 mM, for example 0.005 mM or 1 mM.

In some embodiments, the promoter-metal medium further comprises an acid, a base, and/or pH buffers. The acid may be, for example, hydrochloric acid. The base may be, for example, sodium hydroxide. The pH buffer may be, for example, a potassium phosphate buffer. In particular embodiments, the pH buffer adjusts the pH of the promoter-metal medium to anywhere in the range of 0 and 14. In certain embodiments, the pH of the promoter-metal medium is between 3 and 9, for example, a pH of 3-7, 3.5-7.5, 6.5-8.5, about 7, or about 3. In some aspects, the pH of the promoter-metal medium is 7±0.5, 7±0.4, 7±0.3, 7±0.2, 7±0.1, 7±0.05, 3±0.5, 3±0.4, 3±0.3, 3±0.2, 3±0.1, or 3±0.05.

c. Gas-Transfer Membrane:

The gas-transfer membrane used in the catalytic reactor system does not have pores in its wall (i.e., a non-porous membrane). The lack of pores in the membrane enables transferring gas (for example, hydrogen (H₂)) in a bubble-free form at controllable rates. In some embodiments, the membrane is a hollow-fiber membrane. In such embodiments, gas is supplied to the lumen of the hollow-fiber membrane (the gas-phase side). Accordingly, catalyst film would be anchored to the outer surface of the hollow-fiber membrane (the liquid-phase side). In other embodiments, the membrane is a flat- or curled-sheet membrane. In such embodiments, hydrogen gas is supplied to one side of the sheet membrane (the gas-phase side), while catalyst film is anchored to the other surface of the sheet membrane (the liquid-phase side).

The membrane may be made of a variety of polymeric materials, for example polypropylene, polyurethane, polysulfone, or composite forms. In certain embodiments, the thickness of the gas-transfer membrane is may be 50-70 m, for example between 50-55 m.

In particular embodiments, the gas-transfer membrane is a non-porous polypropylene hollow-fiber membrane (200 μm OD, 100-110 μm ID, wall thickness 50-55 μm).

d. Hydrogen-Gas Source

The hydrogen gas source can be any reliable source of H₂ gas, for examples, a gas storage tank having pressurized H₂ gas, a H₂ generator via water electrolysis, or a methane reformer. In some embodiments, the H₂ purity is over 99%. In some embodiments, the H₂-gas source include a built-in or external gas pressure regulator. The gas pressure regulator regulates the pressure of H₂ gas from the gas storage tank to the gas-phase side of the membrane. In particular implementations, the gas pressure regulator regulates the pressure of H₂ gas so that H₂ gas is delivered to the gas-phase side of the membrane at no more than about 20 psig, for example, 2-20 psig, 5-20 psig, 2-15 psig, 2.5-15 psig, 2-20 psig, 2-10 psig, or 10-20 psig.

System and Method of Removing Contaminants from a Fluid

Also described herein are a MCfR system comprising a multi-metal catalyst film that can remove oxyanions (such as nitrate, nitrite, perchlorate, chlorate, chromate, and selenate), pesticides (such as chlorophenols, 2,4-D, dicamba, and atrazine), disinfection byproducts (such as trichloroacetic acid, bromochloroiodomethane, and NDMA), organic solvents (such as TCE, TCA, and chloroform), freons, explosives (such as RDX, HMX, and TNT), and/or per- and poly-fluoroalkyl substances (PFAS) (such as PFOA and PFOS) from water and wastewater. The catalyst reactor system comprises a non-porous gas-transfer membrane, a hydrogen (H₂) gas source, and a catalyst film comprising nanoparticles of core metal and of at least one promoter metal (the multi-metal catalyst film) that is deposited on the non-porous gas-transfer membrane. The nanoparticles and the H₂ gas are configured to catalyze the reduction of the described contaminants.

The operational conditions of the catalytic reactor system can be conveniently and accurately tuned for optimizing the conditions to reduce particular contaminants. For example, the selection of particular metals for the core metal and the promoter metal and their amount in the core-metal medium and promoter-metal medium for the production of the multi-metal catalyst film, the pH in the liquid comprising the contaminants, the core-metal medium, or the promoter-metal medium, H₂ pressure, and surface-loading rate of the contaminant each may be adjusted to optimize conditions for catalytic reduction of certain contaminants. In particular embodiments, the hydraulic retention

The described methods of removing the aforementioned contaminants from a fluid comprises establishing a multi-metal catalyst film; contacting a fluid containing contaminants with the multi-metal catalyst film; and contacting the multi-metal catalyst film with H₂ gas at a sufficient partial pressure to reduce the contaminants. The multi-metal catalyst film comprises a core-metal film and nanoparticles of at least one promoter metal, wherein the core metal film is deposited on a non-porous gas-transfer membrane and the nanoparticles of the at least one promoter metal are deposited on the core metal film. The core metal and promoter metal are different. The core metal film comprises nanoparticles of at least one core metal selected from the group consisting of: gold, silver, platinum, palladium, rhodium, and ruthenium, and the at least one promoter metal is selected from the group consisting of: gold, silver, platinum, palladium, rhodium, ruthenium, iridium, osmium, copper, tin, nickel, molybdenum, wolframium, rhenium, indium, gallium, and cobalt.

An optimal partial pressure of H₂ gas provided to remove the large variety of oxidized contaminants is 10-30 psig, for example, about 20 psig.

Illustrative, Non-Limiting Examples in Accordance with Certain Embodiments

The disclosure is further illustrated by the following examples that should not be construed as limiting. The contents of all references, patents, and published patent applications cited throughout this application, as well as the figures, are incorporated herein by reference in their entirety for all purposes.

### 1. Coating Methods of Multi-Metal Nanocatalysts

After the set-up of a new MCfR, a film of multi-metal nanocatalyst needs to be formed on the liquid phase side of the membrane fibers or the outside of hollow membrane fibers. The first step is formation of the core metal(s) film, which can be monometallic, bimetallic, or multi-metallic. Once the core metal film is formed, it is then decorated by promoter metals to ultimately form the multi-metal nanocatalyst film described herein.

a. Forming the Core Metal(s)

The key is to feed the MCfR with a medium containing one or a mixture of two or more metal-ion precursors so that the single metal reduces itself or that two or more metals simultaneously co-reduce to form a catalyst film. Combinations of metal-ion precursors are shown in Table 1. The metals listed in the first column, labeled as metal A, are autocatalytic and at least one member must be included in the core-metal medium. The metals listed across the top row, labeled as metal B, are non-autocatalytic and can be additional components of the core-metal medium.

TABLE 1
The possible combination of metal for forming the core metal film

| | B | | | | | | | | | | |
|---|---|---|---|---|---|---|---|---|---|---|---|
| A | Ir | Os | Cu | Sn | Re | M | W | Ga | In | Co | Ni |
| Pt | x | x | x | x | x | x | x | x | x | x | x |
| Pd | x | x | x | x | x | x | x | x | x | x | x |
| Rh | x | x | x | x | x | x | x | x | x | x | x |
| Ru | x | x | x | x | x | x | x | x | x | x | x |
| Au | x | x | x | x | x | x | x | x | x | x | x |
| Ag | x | x | x | x | x | x | x | x | x | x | x |

For the preparation of the core metal film, the core-metal medium comprises at least one metal in metal A and may further comprise a metal in metal B. Taking monometallic catalyst and mixed A/B bimetallic catalyst as an example, the method is summarized as follows:

In the MCfR system with a bare membrane, H₂ pressure is set at 10-20 psig. Then the reactor is filled with A^{x+} or A^{x+} and B^{y+} mixed solution (aqueous solutions of A or B). The concentrations of A and B can be adjusted from 0.01-100 mM.

On the membrane's outer surfaces, dissolved A^{x+} in the bulk liquid is autocatalytically reduced by the H₂ to form A⁰ NPs that are simultaneously deposited as a A⁰-film; B^{y+} reduction to B is induced by A⁰ catalysis. If A^{x+} and B^{y+} can be autocatalytically reduced, they will form alloy catalysts as the core.

b. Forming the Decoration Metals

The key to decoration is to successively feed the MCfR with a medium containing other metal-ion precursors after the formation of A⁰-NP or A⁰B—NP—the promoter-metal medium. After the complete reduction and formation of the first nanocatalyst film (the core metal film), the second promoter metal precursor (different from the metals in the core metal film but can be one or more metals from metal A or metal B) provided to the MCfR via a promoter-metal medium. The promoter metal ion is catalytically reduced so that another layer of nanoparticles deposits on top of the A⁰-film or A⁰B-film (the core metal film). In other words, the promoter-metal nanoparticles decorate the core metal film.

The concentration of the promoter metals in the promoter-metal medium is usually less than the concentration of the metals in the core-metal medium. In the MCfR system, the H₂ pressure is set at 10-20 psi. This process could be repeated to decorate one or more nanocatalyst layers to form a multi-metal nanocatalyst. The concentration of the promoter metals can be adjusted from 0.001-5 mM.

After the formation of multi-metal nanocatalysts in the MCfR, operating conditions are adjusted to search for the proper conditions by testing target contaminants in several stages. During the testing, the MCfR can be operated in the batch mode and liquid samples can be collected accordingly to monitor the variation of target contamination in the effluent.

c. Activation of Decoration Bimetallic Catalysts MCfR: Examples of Forming Decoration Pd/Rh and Pd/Ir

In this example, two bench-scale MCfRs featuring 5:0.05 Pd/Rh-film and 5:0.05 Pd/Ir-film were prepared in ambient conditions (23° C. and 1 atm). Pd/Rh metal precursors were 5 mM Pd(II) and 0.05 mM Rh(III) in the two sequentially applied media and Pd/Ir metal precursors were 5 mM Pd(II) and 0.05 mM Ir(IV) in the two sequentially applied media.

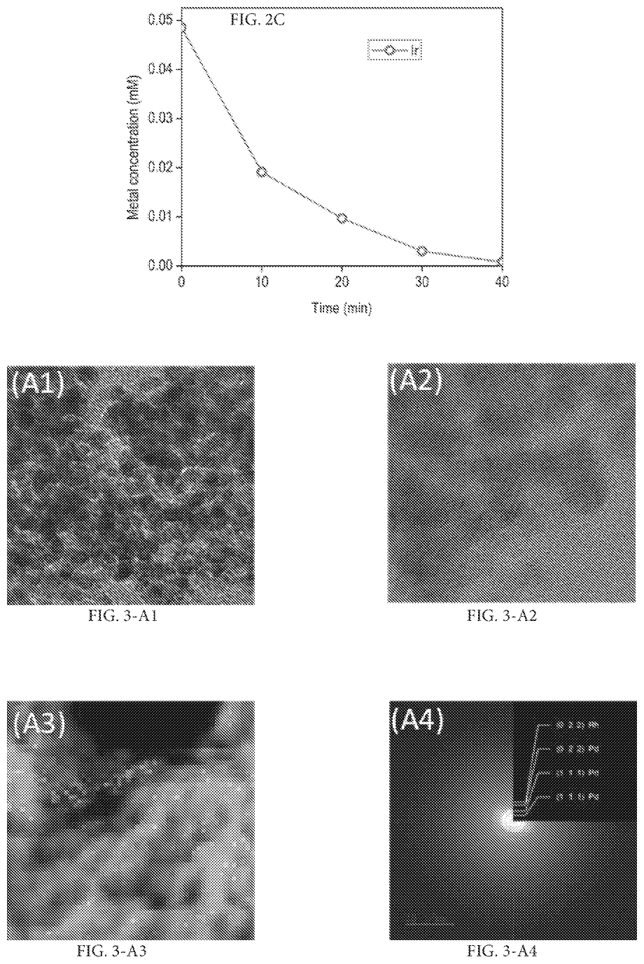

In forming decorating Pd/Rh (FIGS. 2A and 2B), with 5 mM Pd(II) precursor fed, over 99% Pd was reduced within 180 min. This rapid autocatalytic synthesis of metallic Pd⁰ had a yield >99.9%, spontaneously coating 11.2 g Pd/m² on the membrane. After the complete reduction of Pd and formation of Pd⁰NPs, the sequential decoration metal precursor Rh(III) was supplied. With the high reduction ability of Pd⁰NPs, Rh(III) was reduced rapidly, with over 99% removal in 40 mins. This yielded 0.1 g Rh/m² decorating on the first layer of 11.2 g Pd/m² Pd⁰.

In forming decorating Pd/Ir (FIGS. 2A and 2C), the process was similar. After the complete reduction of Pd and formation of Pd⁰NPs, the sequential decoration metal precursor Ir(IV) was supplied. With the high reduction ability of Pd⁰NPs, Ir(IV) was reduced rapidly, with over 99% removal in 40 mins. This yielded 0.2 g Ir/m² decorating on the first layer of 11.2 g Pd/m² Pd⁰.

FIGS. 3-A1 to 3-A2 show that the morphology of the cross-section of the multi-metal catalyst. The edge of the nanoparticles could be clearly identified, with the average size of the nanoparticles at about 5 nm. EELS (Electron Energy Loss Spectroscopy) mapping further displays that, in decoration methods (FIG. 3-A3), Rh⁰ was only a “decoration” on the Pd⁰ surface. The diffraction patterns shown in FIG. 3-A4 indicate two different planes of Pd⁰ occur, including (1 1 1) and (2 2 0), but only one plane of Rh⁰ occurs, (2 2 0).

### 2. Comparison of the Activation of Bimetallic Catalysts Formed Using a Single Precursor Medium and Formed Using the Decoration Method Described Herein

Two bench-scale MCfRs featuring Pd/Rh-film were prepared in ambient conditions (23° C. and 1 atm). For the single precursor medium to establish the catalyst film (a mixed Pd/Rh film), the metal ratio was 2.5 mM Pd ions to 2.5 mM Rh ions. For the decoration methods, the ratio of Pd ion in the core-metal medium to the Rh ion in the promoter-metal medium was 5 mM Pd ions to 0.05 mM Rh ions.

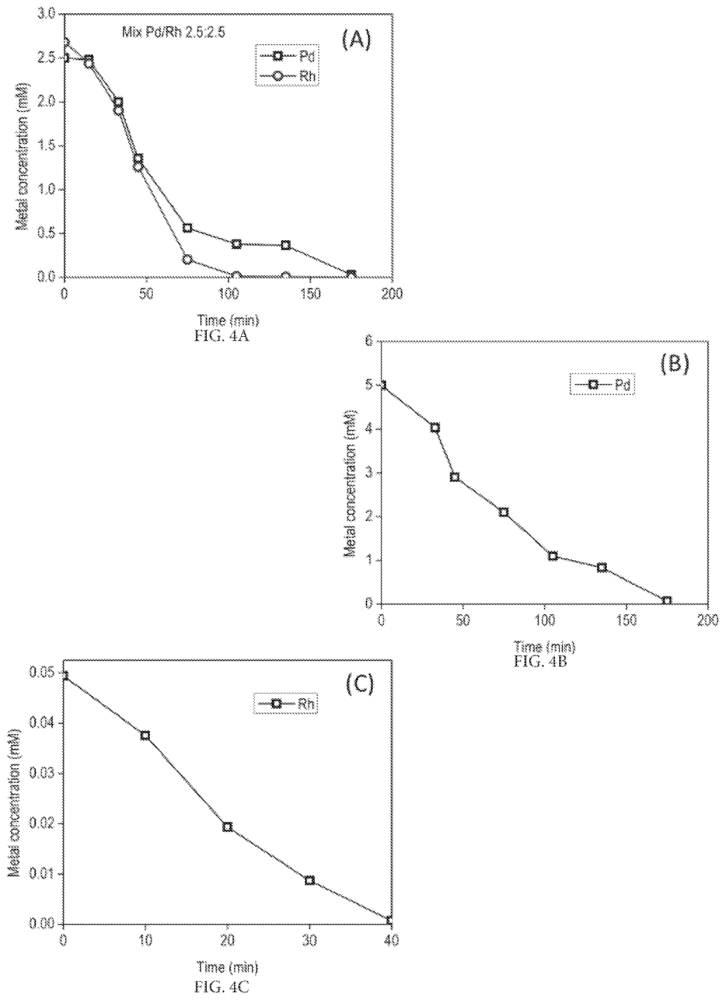

With the single precursor medium, Pd(II) and Rh(III) were reduced simultaneously, with more than 99% of the total Pd and Rh converted to Pd⁰ and Rh⁰ by 180 minutes (FIG. 4A). This rapid autocatalytic synthesis of metallic Pd⁰ and Rh⁰ had a yield >99.9%, spontaneously coating 5.6 g Pd/m² and 5.6 g Rh/m² on membranes within 180 minutes. In the decoration method, Pd was reduced first, with over 99% removal within 180 min (FIG. 4B). After the complete reduction of Pd and formation of Pd⁰NPs, the sequential decoration metal precursor Rh(III) was supplied. With the high reduction ability of Pd⁰NPs, Rh was reduced rapidly, with over 99% removal in 40 mins (FIG. 4C). This rapid catalytic synthesis of metallic Pd⁰ and Rh⁰ had a yield >99.9%, spontaneously coating 11.2 g Pd/m² and 0.1 g Rh/m² on membranes.

Transmission electron microscopy (TEM) images show that the morphology of the cross-section of the mixed Pd/Rh-film was different from the Pd/Rh film produced according to the decoration methods described herein. In the decoration method, the edge of the nanoparticles could be clearly identified. The mixed Pd/Rh-film possibly comprises alloys of Pd and Rh. EELS mapping comparison showed that Pd⁰ and Rh⁰ in the mixed Pd/Rh-film were distributed homogenously, while Rh⁰ was only a “decoration” on the Pd⁰ surface in the Pd/Rh film produced according to the decoration methods described herein. Unlike the diffraction pattern shown in FIG. 3-A4, Pd⁰ in the mixed Pd/Rh-film appears on four planes: (1 1 1), (2 0 0), (2 2 0), and (3 1 1), the Rh⁰ appears on two planes: (2 0 0) and (4 0 0).

### 3. Examples of Applications of Decoration Bimetallic Catalysts MCfR

In this example, we supplied two cases of decoration bimetallic catalysts, Pd⁰/Rh⁰ and Pd⁰/Ir⁰. Pd⁰ has limited ability in defluorinating PFOA at neutral pH, but the decoration bimetallic catalysts can defluorinate PFAS at neutral pH with high efficiency. For this case, we display two examples with different decoration metal ratios.

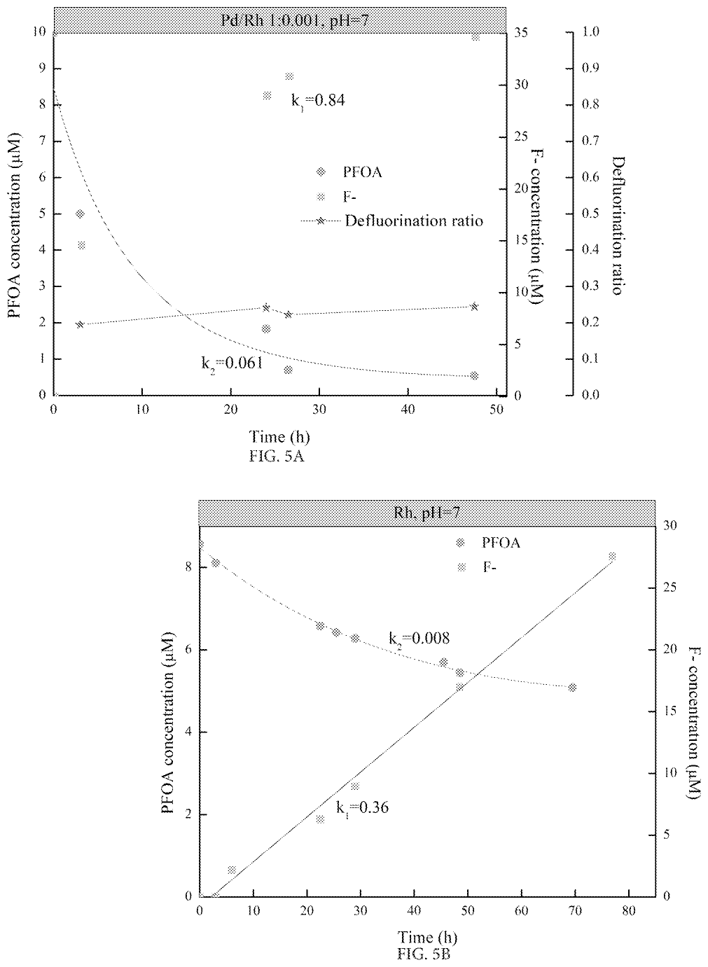

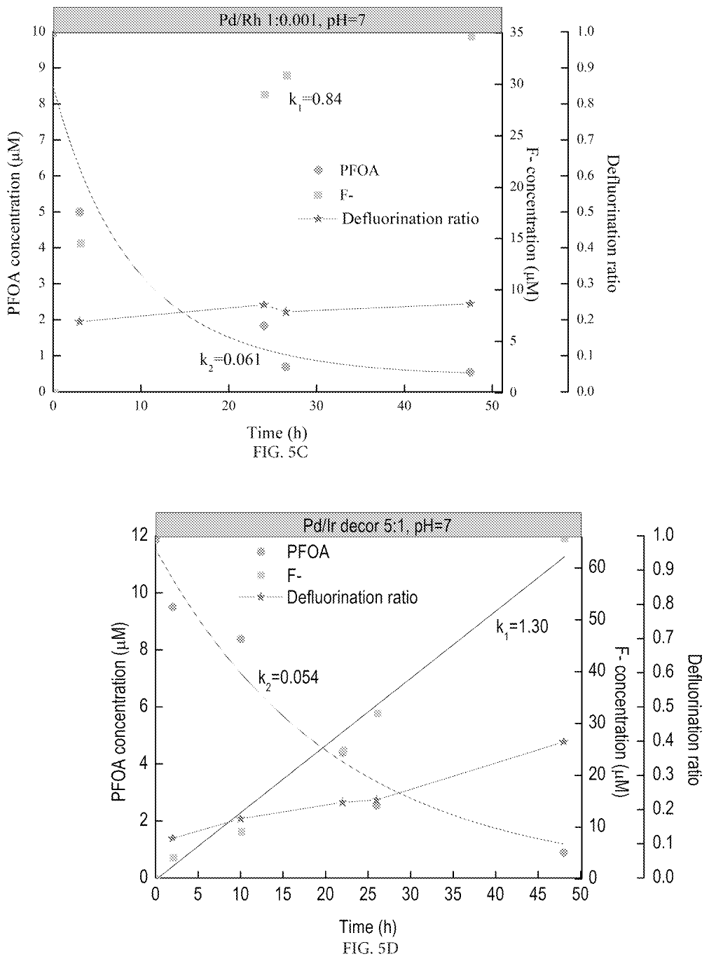

The results of PFOA and F⁻ concentrations for Pd⁰NPs are shown in FIG. 5A. While all 10 μM of PFOA was removed in 24 h, F⁻ release was minimal. This indicates that Pd⁰NP catalysis was deactivated at pH 7. Therefore, PdNPs had only adsorption ability for PFOA removal.

The results of PFOA and F⁻ concentrations for Rh⁰NPs are shown in FIG. 5B. We detected over 41% PFOA depletion with a pseudo-first-order rate of 0.008 h⁻¹ with reductive defluorination (27.6 μM F⁻ accumulation, accounting for 22% of the total F in the about 9 μM PFOA) with a pseudo-zero-order rate of 0.36 μM/h during the 77-hour test.

The results of PFOA and F⁻ concentrations for 5/0.005-mM Pd/RhNPs are shown in FIG. 5C. We detected over 94.6% PFOA depletion with a pseudo-first-order rate of 0.061 h−1 with reductive defluorination (34.6 μM F⁻ accumulation, accounting for 23.2% of the total F in the about 9.96 μM PFOA) with a pseudo-zero-order rate of 0.84 μM/h in the H₂-MPfR during the 48-hour test.

The results of PFOA and F⁻ concentrations for 5/1-mM Pd/IrNPs are shown in FIG. 5D. We detected over 92.6% PFOA depletion with a pseudo-first-order rate of 0.054 h⁻¹ with reductive defluorination (65.6 μM F⁻ accumulation, accounting for 36.8% of the total F in about 12 μM PFOA) with a pseudo-zero-order rate of 1.30 μM/h in the H₂-MCfR during the 48-hour test.

Summarized in FIG. 5E, 5:0.05 Pd⁰/Rh⁰ and 5:1 Pd⁰/Ir⁰ showed much higher defluorination rates than mono-Pd⁰ and mono-Rh⁰. This was caused by the synergistic effect of the bimetallic catalyst: Pd⁰ played a key role in adsorbing PFOA and H₂, while Rh⁰ or Ir⁰ was responsible for carbon-fluoride dissociation. Although Ir(IV) cannot be autocatalytic reduced to form Ir⁰NPs, Pd⁰ catalysis, allowed Ir(IV) to be reduced and form Ir⁰NPs; this combination show much higher defluorination rate of PFOA than mono-Pd⁰ at pH 7.

As shown in this example, multi-metal catalysts have higher catalytic activities at environmentally relevant conditions than the monometallic catalyst.

### 4. Examples of Applications of Decoration Bimetallic Catalysts MCfR

Several cases of decoration bimetallic catalysts including Pd⁰Sn, Pd⁰Cu⁰, Pd⁰Re, Pd⁰Mo, Pd⁰W, Pd⁰Rh⁰, and Pd⁰Ru⁰ were supplied for reducing nitrate, chlorate, and perchlorate. Table 2 lists the running conditions for reducing nitrate, chlorate, and perchlorate. Pd⁰ is incapable of reducing nitrate, chlorate, and perchlorate. However, the formation of varied kinds of decoration bimetallic catalysts gave complete nitrate reduction.

TABLE 2
Running conditions for removing contaminants in a liquid

| | | |
|---|---|---|
| Contaminant (mM) | H₂ gas (psig) | pH of liquid |

| | | | |
|---|---|---|---|
| Nitrate | 4 | 20 | 4 or 7 |
| Chlorate | 0.1 | 20 | 3 |
| Perchlorate | 0.1 | 20 | 3 |

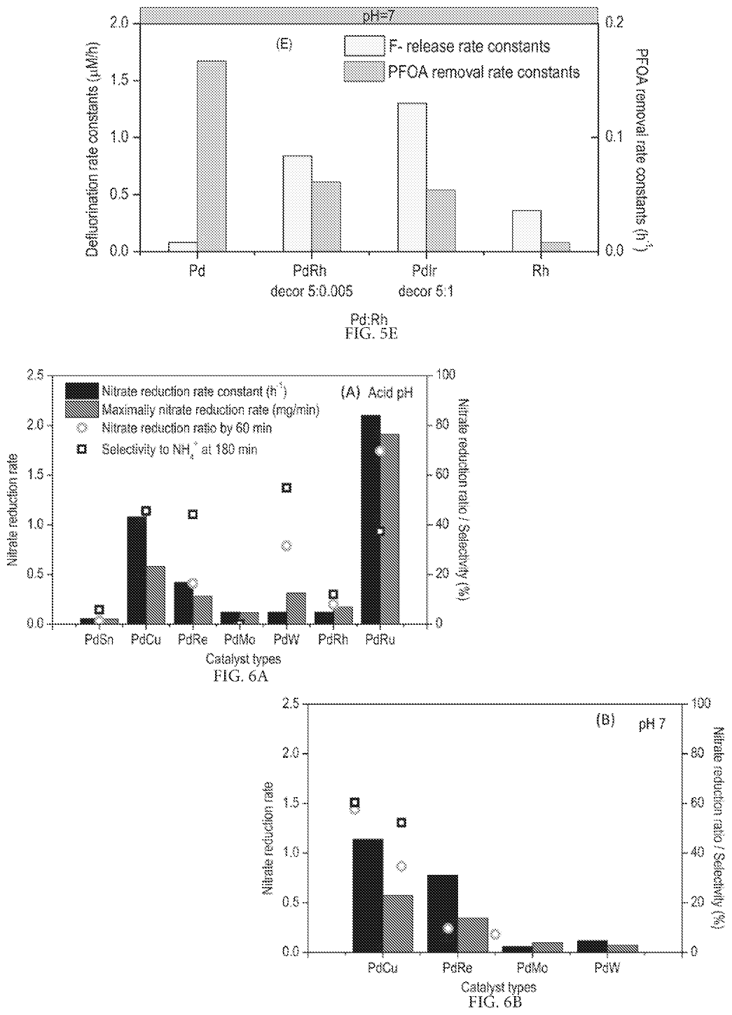

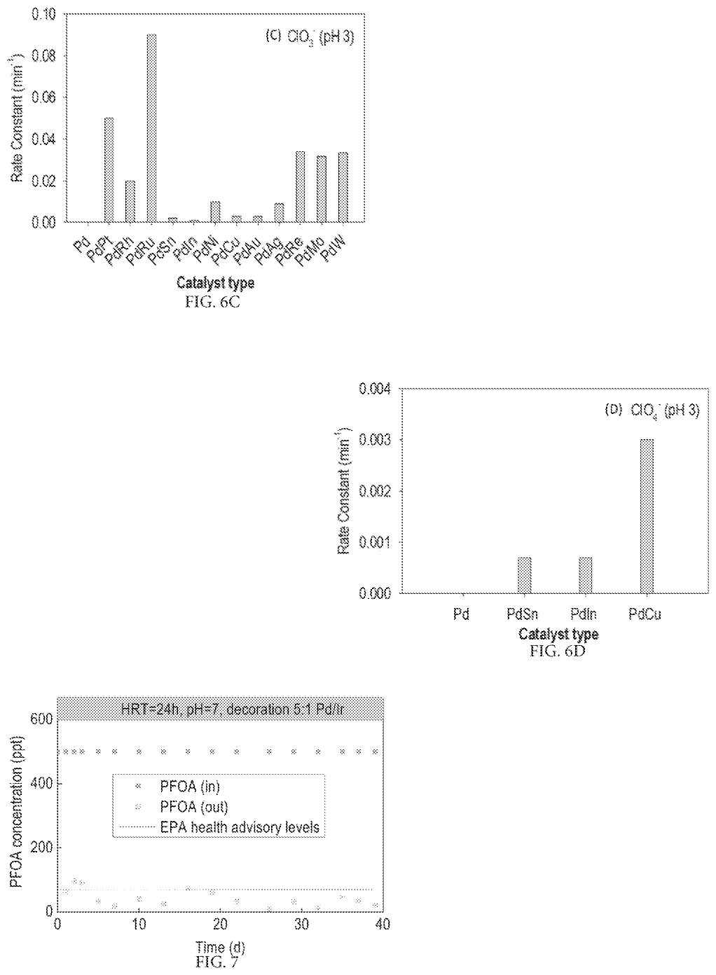

As shown in FIG. 6A, at acidic pH, Pd⁰Sn, Pd⁰Cu⁰, Pd⁰Re, Pd⁰Mo, Pd⁰W, Pd⁰Rh⁰, and Pd⁰Ru⁰ can reduce nitrate. The three combinations giving the fastest kinetics are Pd⁰Ru⁰, Pd⁰Cu⁰, and Pd⁰Re, with the highest catalytic rates (Pd⁰Ru⁰) of 0.070 L·g_{Pd}⁻¹·min⁻¹.

As shown in FIG. 6B, at neutral pH, Pd⁰Cu⁰, Pd⁰Re, Pd⁰Mo, Pd⁰W show capable of reducing nitrate, with the highest catalytic rates (Pd⁰Cu⁰) of 0.038 L·g_{Pd}⁻¹·min⁻¹. The nitrate reduction rate of bimetallic catalysts Pd⁰Cu⁰ was even slightly higher at neutral pH than that in acidic pH and Pd⁰Cu⁰ in our system manifested much higher catalytic activity than most of the bimetallic catalysts such as catalysts supported on titania, CeO₂, MnO₂, or AlO₃.

As shown in FIG. 6C, Pd⁰Pt⁰, Pd⁰In⁰, Pd⁰Ni, Pd⁰Au⁰, Pd⁰Ag⁰, Pd⁰Sn, Pd⁰Cu⁰, Pd⁰Re, Pd⁰Mo, Pd⁰W, Pd⁰Rh⁰ and Pd⁰Ru⁰ manifested abilities in reducing chlorate at acidic pH, with the highest catalytic rates (Pd⁰Ru⁰) of 0.19 L·g_{Pd}⁻¹·min⁻¹.

As shown in FIG. 6D, Pd⁰In⁰, Pd⁰Sn, and Pd⁰Cu⁰ manifested abilities in reducing perchlorate, with the highest catalytic rates (Pd⁰Cu⁰) of 0.006 L·g_{Pd}¹·min⁻¹.

These examples demonstrate that decoration bimetallic catalysts can complete reactions that are not possible with monometallic catalysts.

For the formation of Pd⁰Sn, Pd⁰Cu⁰, Pd⁰Re, Pd⁰Mo, Pd⁰W, Pd⁰Rh⁰, and Pd⁰Ru⁰ multi-metal catalyst films, the concentration Pd ions in the core-metal medium was 5 mM, while the concentration of the promoter metal ions in the promoter-metal medium was 0.005 mM for Rh and 1 mM for the other promoter metals. The pH of the core-metal medium was 7, while the pH of the promoter-metal medium was 7 for Rh and Ir and 3 for the other promoter metals.

The partial pressure of H₂ gas delivered to the liquid-phase of the gas-transfer membrane to establish the core metal film was 20 psig. The partial pressure of H₂ gas delivered to the liquid-phase of the gas-transfer membrane and the core metal film to decorate the core metal film with promoter metal nanoparticles to ultimately establish the multi-metal catalyst film was also 20 psig. For both the establishment of the core metal film and the multi-metal catalyst film, providing their respective medium to the gas-transfer membrane for 24 hours was sufficient to load the gas-transfer membrane with the core metal nanoparticles and to decorate the core metal film with promoter metal nanoparticles. The loading density of the core metal nanoparticles was 11 mmol/m². The loading density of the promoter metal nanoparticles was 0.0011 mmol/m² for Rh and 2.2 mmol/m² for all over promoter metals.

### 5. Applications of Decoration Bimetallic Catalysts MCfR: Examples of Long-Term Removal of PFOA Catalyzed by Pd/Ir Under Continuous Operation

This example demonstrates one advantage of decoration bimetallic catalysts in our system: achieving long-term removal of contamination. FIG. 7 shows the PFOA concentrations in the influent and effluent of MCfR with the decoration 5:1 Pd⁰/Ir⁰ with the environmentally relevant concentrations of PFOA during over 39 days. The running condition was H₂ pressure at 20 psig, pH at 7, and hydraulic retention time (HRT) at 24 h. Within 1 day, the effluent PFOA decreased sharply to <60 μM (or 88% removal). Then, the effluent concentration of PFOA stabilized below the EPA health advisory level (70 ppt) at 43±27 ppt (or 91±5% removal) for the following 38 days. This indicated the decoration bimetallic catalysts in the MCfR were capable of long-term treatment of contaminants.

### 6. Establishing and Testing a Trimetallic Catalyst Film

Developing a catalyst that can simultaneously catalyze reduction or hydrogenation of various types of oxidized contaminants (e.g., oxyanions like nitrate and halogenated organics like PFOA) is an intriguing challenge in catalyst synthesis. Catalytic properties of a catalyst film comprising three metals can be tailored better than that of a single monometallic catalyst.

A trimetallic catalyst film comprising nanoparticles of three metals is formed by combining three different metals in one. According to the methods disclosed herein, a trimetallic catalyst film can be formed in the following ways: (1) three metals coated in sequence, (2) one metal as a core and two mixed metals as decoration metals, and (3) two mix metals as the core and one decoration metal as a promoter. In this example, a trimetallic catalyst film was made with two metals forming the core metal film (palladium and rhodium) and one promoter metal (ruthenium) used to decorate the core metal film to result in the trimetallic catalyst. Specifically, the trimetallic catalyst film was formed by first using a core-metal medium containing 2.5 mM palladium ions and 2.5 mM rhodium ions to form the bimetallic core catalyst film. The bimetallic core catalyst film was then decorated with ruthenium using a promoter-metal medium containing 1 mM ruthenium ions.

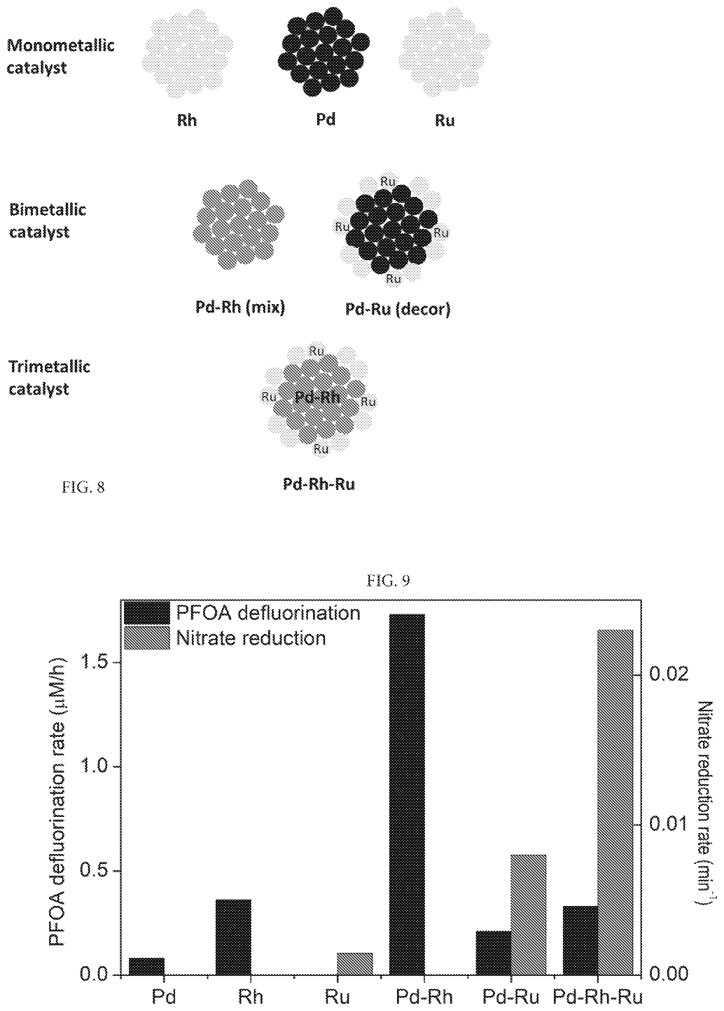

The nitrate-reduction and defluorination properties of the trimetallic catalyst film at neutral pH were compared with those of a monometallic palladium catalyst film, a monometallic rhodium catalyst film, a monometallic ruthenium catalyst film, a bimetallic catalyst film comprising palladium and rhodium, a bimetallic catalyst film comprising a palladium nanoparticle as the core metal film decorated with ruthenium nanoparticles (see FIGS. 8 and 9). The tests involved evaluating reduction of nitrate in a fluid comprising 4 mM nitrate or defluorination of a fluid containing 10 μM PFOA.

The monometallic catalyst films comprising palladium or rhodium cannot reduce nitrate, but they are capable of defluorinating PFOA, while the monometallic catalyst film comprising ruthenium can reduce nitrate but cannot defluorinating PFOA (FIG. 9). While a catalyst film comprising palladium and rhodium nanoparticles is highly efficient in defluorinating of PFOA at neutral pH, it is still unable to reduce nitrate. On the other hand, bimetallic catalyst film comprising a palladium nanoparticle as the core metal film decorated with ruthenium nanoparticles possesses limited capacity for PFOA defluorination and nitrate reduction (albeit the combination resulted in a synergistic increase in nitrate reduction and defluorination properties compared to the corresponding monometallic catalyst films).

The produced trimetallic catalyst film comprising a core metal film of palladium and rhodium nanoparticles with the core metal film decorated with ruthenium nanoparticles produced the best nitrate reduction of all of the catalyst films tested. However, the defluorination rate was decreased compared to bimetallic catalyst film comprising palladium and rhodium, though it increased compared to the bimetallic catalyst film comprising a palladium nanoparticle as the core metal film decorated with ruthenium nanoparticles. These results suggest that ruthenium decoration on a catalyst film comprising palladium and rhodium may deteriorate the activity of the bimetallic catalyst film comprising palladium and rhodium. However, the bimetallic catalyst film comprising palladium and rhodium enabled faster nitrate reduction catalyzed by ruthenium nanoparticles.

1. A method of establishing a catalyst film for removal of oxidized contaminants from a fluid, the method comprising:
providing a non-porous gas-transfer membrane, wherein the non-porous gas-transfer membrane comprises a gas-phase side and a liquid-phase side;
contacting the liquid-phase side of the non-porous gas-transfer membrane with a core-metal medium, wherein the core-metal medium comprises core metal ions;
contacting the gas-phase side of the non-porous gas-transfer membrane with hydrogen (H₂) gas at a sufficient partial pressure to convert at least 90% of the core metal ions in the core-metal medium to an elemental form, wherein the elemental form of the core metal is in the form of a nanoparticle and is deposited on the liquid-phase side of the non-porous gas-transfer membrane, thereby forming a core metal film;
contacting the liquid-phase side of the non-porous gas-transfer membrane deposited with the core metal film with a promoter-metal medium, wherein the promoter-metal medium comprises promoter metal ions; and
contacting the gas-phase side of the non-porous gas-transfer membrane deposited with the core metal film with H₂ gas at a sufficient partial pressure to reduce at least 90% of the promoter metal ions in the promoter-metal medium to an elemental form or a lower oxidation state that is greater than 0, wherein the reduced promoter metal ions is in the form of a nanoparticle and is deposited on the core metal film thereby forming a multi-metal catalyst film on the liquid-phase side of the non-porous gas-transfer membrane.

2. The method of claim 1, further comprising:
combining at least one salt of a core metal and a solvent to produce the core-metal medium; and
combining at least one salt of a promoter metal and a solvent to produce the promoter-metal medium.

3. The method of claim 2, wherein the solvent of the core-metal medium and the solvent of the promoter-metal medium each is selected from the group consisting of:
water, an aqueous salt solution, hydrochloric acid, methanol, ethanol, acetonitrile, toluene, dichloromethane, chloroform, tetrahydrofuran, and a combination thereof.

4. The method of claim 1, wherein the method establishes a reactor for long-term removal of oxidized contaminants from a fluid, the method further comprises:
providing hydrogen (H₂) gas source, wherein the H₂ gas source delivers H₂ gas to the gas-phase side of the non-porous gas-transfer membrane.

5. (canceled)

6. (canceled)

7. The method of claim 3, wherein the solvent of the core-metal medium and the solvent of the promoter-metal medium each is selected from deionized water or the aqueous salt solution.

8. The method of claim 2, wherein:
the at least one salt of the core metal is selected from the group consisting of: gold salt, silver salt, platinum salt, palladium salt, rhodium salt, and ruthenium salt;
the at least one salt of the promoter metal is selected from the group consisting of: gold salt, silver salt, platinum salt, palladium salt, rhodium salt, ruthenium salt, iridium salt, osmium salt, copper salt, tin salt, nickel salt, molybdenum salt, wolframium salt, rhenium salt, indium salt, gallium salt, and cobalt salt; and
the promoter metal is different from the core metal.

9. The method of claim 8, wherein the core-metal medium comprises a salt of a first core metal and a salt of second core metal, wherein:
the salt of the salt of the first core metal is selected from the group consisting of: gold salt, silver salt, platinum salt, palladium salt, rhodium salt, and ruthenium salt;
the salt of the second core metal is selected from the group consisting of: gold salt, silver salt, platinum salt, palladium salt, rhodium salt, ruthenium salt, iridium salt, osmium salt, copper salt, tin salt, nickel salt, molybdenum salt, wolframium salt, rhenium salt, indium salt, gallium salt, and cobalt salt; and
the second core metal is different than the first core metal and the promoter metal.

10. The method of claim 1, wherein the core metal ions comprise at least one metal ion selected from the group consisting of: Au³⁺, Ag⁺, Pt²⁺, Pd²⁺, Rh³⁺, and Ru³⁺.

11. The method of claim 10, wherein the core-metal medium comprises a first core metal ion selected from the group consisting of: Au³⁺, Ag⁺, Pt²⁺, Pd²⁺, Rh³⁺ and Ru³⁺ and a second core metal ion selected from the group consisting of: Au³⁺, Ag⁺, Pt²⁺, Pd²⁺, Rh³⁺, Ru³⁺, Ir⁴⁺, Os⁴⁺, Cu²⁺, Sn²⁺, Ni²⁺, Mo⁶⁺, W⁶⁺, Re⁷⁺, In³⁺, Ga²⁺, and Co²⁺, wherein the second core metal ion is different the first core metal ion and the promoter metal ions.

12. The method of claim 8, wherein the promoter metal ions comprises at least one metal ion selected from the group consisting of: Au³⁺, Ag⁺, Pt²⁺, Pd²⁺, Rh³⁺, Ru³⁺, Ir⁴⁺, Os⁴⁺, Cu²⁺, Sn²⁺, Ni²⁺, Mo⁶⁺, W⁶⁺, Re⁷⁺, In³⁺, Ga²⁺, and Co²⁺.

13. The method of claim 1, wherein the concentration of the core metal ions in the core-metal medium is greater than the concentration of the promoter metal ions in the promoter-metal medium.

14. (canceled)

15. (canceled)

16. (canceled)

17. (canceled)

18. A method of removing contaminants from a fluid, wherein the contaminants are at least one member selected from the group consisting of: an oxyanion, a pesticide, a disinfection byproduct, an organic solvent, a freon, an explosive, and per- and poly-fluoroalkyl substances (PFAS), the method comprising:
contacting a fluid containing contaminants with a multi-metal catalyst film produced according to the method of claim 1; and
contacting the multi-metal catalyst film with hydrogen (H₂) gas at a sufficient partial pressure to reduce the oxidized contaminants.

19. A method of removing contaminants from a fluid, wherein the contaminants are at least one member selected from the group consisting of: an oxyanion, a pesticide, a disinfection byproduct, an organic solvent, a freon, an explosive, and per- and poly-fluoroalkyl substances (PFAS), the method comprising:
establishing a multi-metal catalyst film, the multi-metal catalyst film comprising a core metal film and nanoparticles of at least one promoter metal, wherein:
the core metal film is deposited on a non-porous gas-transfer membrane;
the nanoparticles of the at least one promoter metal are deposited on the core metal film;
the core metal film comprises nanoparticles of at least one core metal selected from the group consisting of: gold, silver, platinum, palladium, rhodium, and ruthenium;
the at least one promoter metal is selected from the group consisting of: gold, silver, platinum, palladium, rhodium, ruthenium, iridium, osmium, copper, tin, nickel, molybdenum, wolframium, rhenium, indium, gallium, and cobalt; and
the core metal and promoter metal are different;
contacting a fluid containing contaminants with the multi-metal catalyst film; and
contacting the multi-metal catalyst film with hydrogen (H₂) gas at a sufficient partial pressure to reduce the contaminants.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A system for removing contaminants from a fluid, the system comprising:
a non-porous gas-transfer membrane;
a catalyst film comprising nanoparticles of at least one core metal and nanoparticles of at least one promoter metal; and
a hydrogen (H₂) gas source,
wherein:
the catalyst film is deposited on the non-porous gas-transfer membrane;
the H₂ gas source provides H₂ gas to the non-porous gas-transfer membrane;
the nanoparticles of the first core metal and the nanoparticles of the at least one promoter metal are configured to catalyze the reduction of contaminants when provided a sufficient amount of H₂ gas to catalyze the reduction of contaminants; and
the contaminants are at least one member selected from the group consisting of: an oxyanion, a pesticide, a disinfection byproduct, an organic solvent, a freon, an explosive, and per- and poly-fluoroalkyl substances (PFAS).

35. The system of claim 34, wherein the nanoparticles have a diameter of less than 100 nm or less than 10 nm.

36. The system of claim 34, wherein the non-porous gas-transfer membrane comprises a gas-phase side and a liquid-phase side, the catalyst film is deposited on the liquid-phase side and the H₂ gas source delivers H₂ gas to the gas-phase side.

37. The system of claim 34, wherein the loading density of the at least one core metal is 9-14 g/m² and the loading density of the at least one promoter metal is about 0.1 g/m².

38. (canceled)

39. The system of claim 34, wherein:
the at least one core metal is selected from the group consisting of: gold, silver, platinum, palladium, rhodium, and ruthenium;
the at least one promoter metal is selected from the group consisting of: gold, silver, platinum, palladium, rhodium, ruthenium, iridium, osmium, copper, tin, nickel, molybdenum, wolframium, rhenium, indium, gallium, and cobalt; and
the at least one promoter metal is different from the at least one core metal.

40. The system of claim 39, wherein the catalyst film comprises nanoparticles of a first core metal selected from the group consisting of: gold, silver, platinum, palladium, rhodium, and ruthenium and a second core metal selected from the group consisting of: gold, silver, platinum, palladium, rhodium, ruthenium, iridium, osmium, copper, tin, nickel, molybdenum, wolframium, rhenium, indium, gallium, and cobalt, the second core metal is different than the first core metal and the at least one promoter metal.

41. The system of claim 34, wherein the contaminants are at least one member selected from the group consisting of: nitrate, nitrite, perchlorate, chlorate, chromate, selenate, chlorophenols, 2,4-D, dicamba, atrazine, trichloroacetic acid, bromochloroiodomethane, NDMA, TCE, TCA, chloroform, RDX, HMX, TNT, PFOA, and PFOS.
